(19) United States
(12) Patent Application Publication
(10) Pub. No.: US 2015/0311630 A1
(43) Pub. Date: Oct. 29, 2015

(54) ELECTRONIC CARD CONNECTOR AND ELECTRONIC DEVICE USING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN LEI, Shenzhen (CN)

(21) Appl. No.: 14/566,972

(22) Filed: Dec. 11, 2014

(30) Foreign Application Priority Data
Apr. 24, 2014 (CN) 201410167515.0

(51) Int. Cl. H01R 13/629

(52) U.S. Cl. CPC H01R 13/62994

(57) ABSTRACT

An electronic card connector includes a tray, a first push rod rotatably attached to a bottom wall, a second push rod and an arc-shaped push rod. The second push rod includes a first end and a second end. The first end resists the first rod body. The second end is used for a user pushing. The arc-shaped push rod includes a fixing portion rotatably attached to the bottom wall and a latching portion. The latching portion engages the tray with the housing. Therein, the second push rod is driven to rotatably push the first push rod, thereby cause the first push rod to resist the latching portion and drive the arc-shaped push rod to rotate so as to disengage the latching portion with the tray.

The subject matter herein relates to an electronic card connector and an electronic device using same.

### BACKGROUND

Electronic card connector, such as Subscriber Identity Model card (SIM card), Secure Digital Memory card (SD card) or the like, can be inserted into an electronic device, so that the electronic device can communicate with other electronic devices or store information.

### BRIEF DESCRIPTION OF THE DRAWINGS

Many aspects of the present disclosure are better understood with reference to the follow drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a partial, isometric view of an embodiment of an electronic device.

FIG. 2 is an exploded isometric view of an embodiment of the electronic device shown in FIG. 1.

FIG. 3 is an isometric view of an embodiment of a tray of the electronic device shown in FIG. 1.

FIG. 4 is a diagram of an embodiment of the electronic device shown in FIG. 1 in a first state.

FIG. 5 is a diagram of an embodiment of the electronic device shown in FIG. 1 in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description can be not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

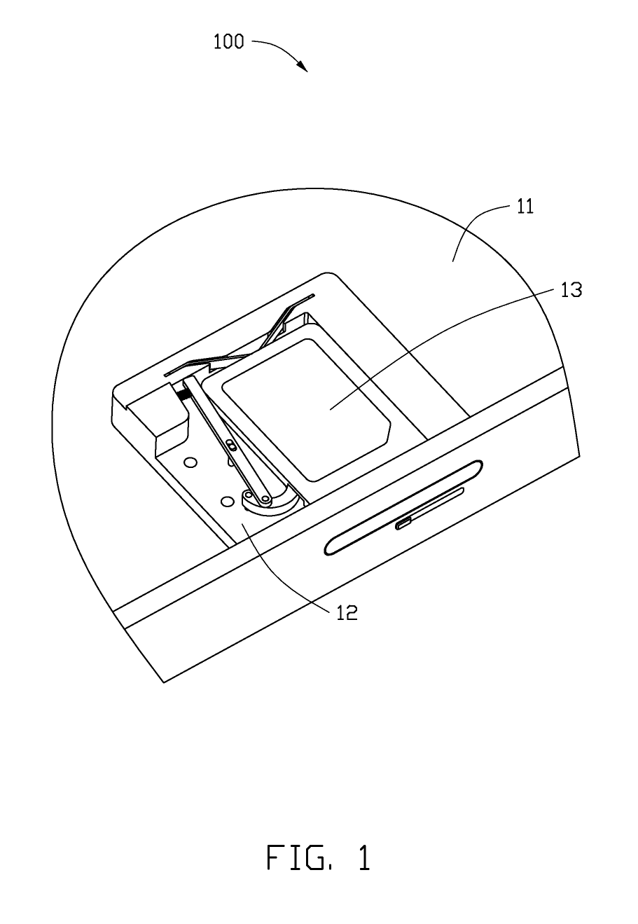

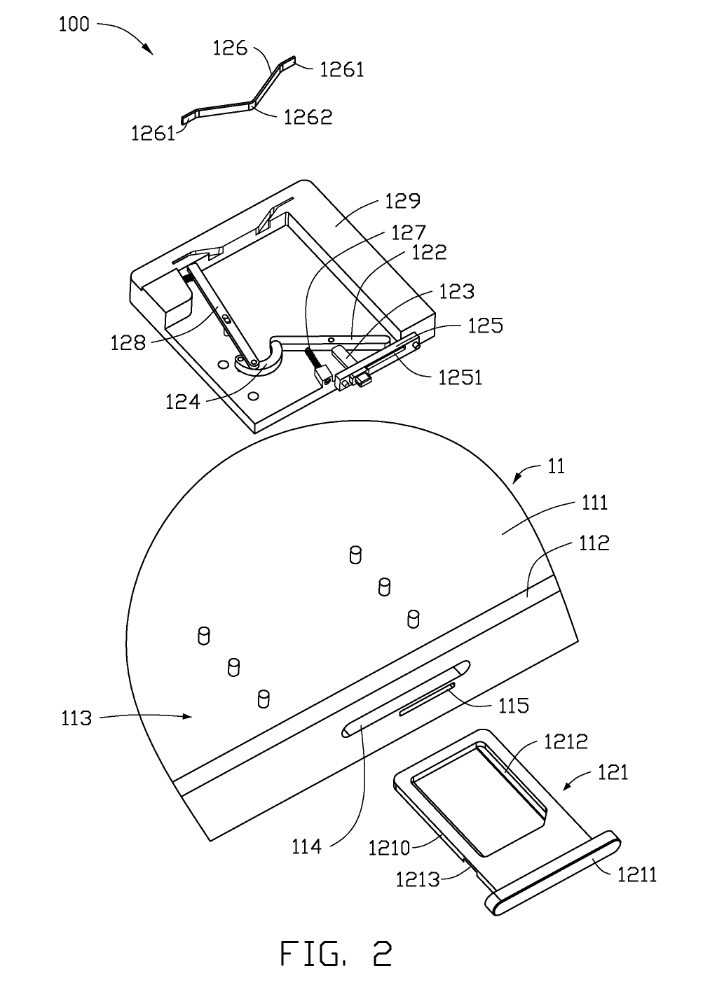

FIGS. 1 and 2 show an electronic device 100. The electronic device 100 can be a mobile phone, or a computer includes, but not limited to, a portable computer, or a tablet computer or a desktop computer. The electronic device 100 can include a housing 11 and an electronic card connector 12. The electronic device 100 can also include other functional modules to fulfill different functions; however, it can be not shown and specifically described for simplification.

The housing 11 can include a bottom wall 111, a peripheral sidewall 112 and other peripheral sidewalls (not shown). The bottom wall 111, the peripheral sidewall 112 and the other peripheral sidewalls can cooperatively define a first receiving space 113. The electronic card connector 12 can be received in the first receiving space 113. The peripheral sidewall 112 can define an opening 114 and a first slide groove 115 adjacent to the opening 114. The opening 114 and the first slide groove 115 can both interconnect with the first receiving space 113.

The electronic card connector 12 can include a tray 121, a first push rod 122, a second push rod 123 and an arc-shaped push rod 124.

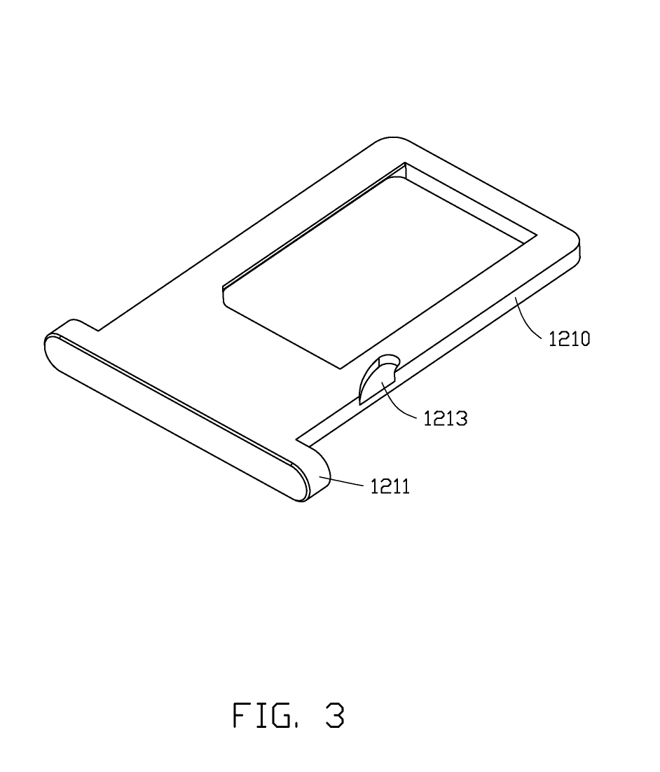

Referring to FIG. 3, the tray 121 can include a tray body 1210 and an end cover 1211 located on one end of the tray body 1210. When in assembly, the tray body 1210 can pass through the opening 114 and receive in the first receiving space 113, and the end cover 1211 can thus receive in the opening 114 and cover the opening 114. The tray body 1210 can define a defined space 1212 and a notch 1213 therein, the defined space 1212 can be located in one side of the tray body 1210 away from the bottom wall 111, and the notch 1213 can be arc-shaped and located in the other side of the tray body 1210 close to the bottom wall 111 and further close to a sidewall of the tray body 1210.

The defined space 1212 can be used for accommodating an electronic card 13. The electronic card 13 can be an SIM (Subscriber Identity Module) card, or an SD (Secure Digital) card or other suitable card. The electronic card 13 can include a number of first conductive contacts (not shown). The bottom wall 111 can include a number of second conductive contacts (not shown). The second conductive contacts can be coupled to the first conductive contacts thus to electronically couple the electronic card 13 with the bottom wall 111.

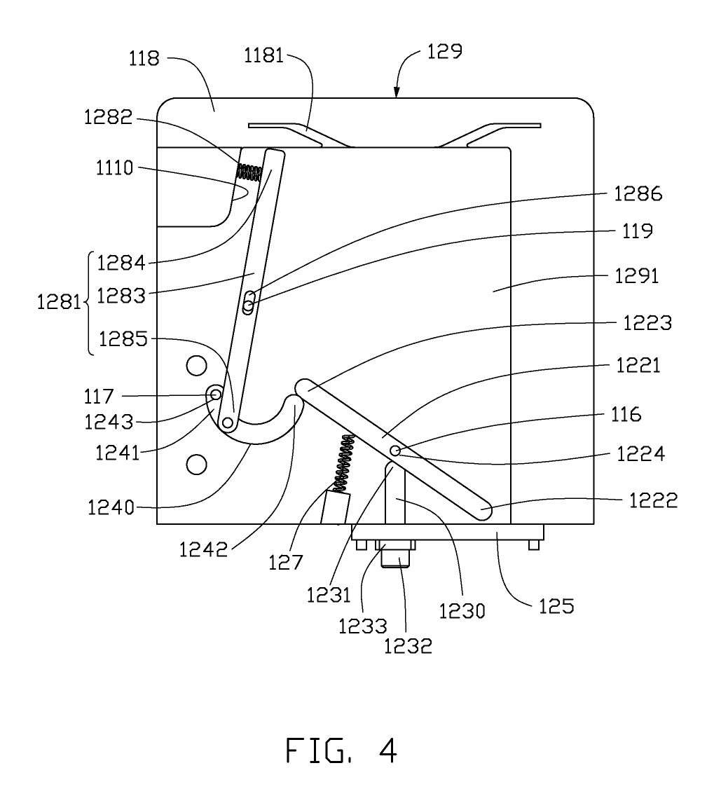

Referring to FIGS. 1, 2 and 4, the first push rod 122 can include a first rod body 1221 coupled to the bottom wall 111 and two arms 1222, 1223 located on two ends of the first rod body 1221. Therein, one of the two arms 1222, 1223 close to the peripheral sidewall 112 can be called as a first arm 1222, and the other of the two arms 1222, 1223 away from the peripheral sidewall 112 can be called as a second arm 1223. In detail, the first rod body 1221 can further define a first through hole 1224; the bottom wall 111 can include a first pivot 116 protruded therefrom; the first pivot 116 can pass through the first through hole 1224 to rotatably couple the first push rod 122 to the bottom wall 111; and the first push rod 122 can rotate about the axis of the first pivot 116. In at least one embodiment, the first pivot 116 can be fixed to the first rod body 1221 or protruded from the first rod body 1221; a corresponding hole can be defined on the bottom wall 111; and the first pivot 116 can receive in the corresponding hole to rotatably couple the first push rod 122 to the bottom wall 111.

The second push rod 123 can include a second rod body 1230, a first end 1231 and a second end 1232. The first end 1231 and the second end 1232 can be located on two ends of the second rod body 1230. The first end 1231 can resist the first rod body 1221, and the second end 1232 can pass through the first slide groove 115 to partially protrude from of the housing 11.

The second rod body 1230 can include a protrusion 1233 protruded therefrom. To simply description, the length of the second end 1232 of the second push rod 123 along a direction perpendicular to the bottom wall 111 can be called as the height of the second end 1232, and the depth of the first slide groove 115 along a direction perpendicular to the bottom wall 111 can be called the height of the first slide groove 115, and the length of the protrusion 1233 along a direction perpendicular to the bottom wall 111 can be called as the height of the protrusion 1233. The height of the second end 1232 can be less than the height of the first slide groove 115. The sum of the height of the second rod body 1230 and the height of the protrusion 1233 can be greater than that of the height of the first slide groove 115. Thus, when the second end 1232 passes through the first slide groove 115, the protrusion 1233 resists the interior side face of the peripheral sidewall 112, so the protrusion 1233 can prevent the second push rod 123 to slip out the first slide groove 115.

The electronic card connector 12 can further include a resist member 125. The resist member 125 can be strip-shaped. The resist member 125 can define a second slide groove 1251. In at least one embodiment, the shape and the size of the second slide groove 1251 can be substantially equal to the shape and the size of the first slide groove 115. The first end 1231 of the second push rod 123 can pass through the second slide groove 1251 firstly and then resist the first rod body 1221. The protrusion 1233 of the second push rod 123 can be located between the resist member 125 and the peripheral sidewall 112. The resist member 125 can resist the protrusion 1233 of the second push rod 123 and be further fixed to the peripheral sidewall 112, thus to prevent the second push rod 123 from moving along a direction from outside of the peripheral sidewall 112 to interior of the peripheral sidewall 112. Thus, the second push rod 123 can only slide in the first slide groove 115 and the second slide groove 1251.

The arc-shaped push rod 124 can be substantially semi-circle shaped. The arc-shaped push rod 124 can include an arc-shaped rod body 1240, a fixing portion 1241 and a latching portion 1242. The fixing portion 1241 and the latching portion 1242 can be located on two ends of the arc-shaped rod body 1240. The fixing portion 1241 can be away from the tray 121 and the latching portion 1242 can be close to the tray 121. In detail, the fixing portion 121 can define a second through hole 1243; the bottom wall 111 can protrude a second pivot 117; and the second pivot 117 can pass through the second through hole 1243 to rotatably couple the arc-shaped push rod 124 to the bottom wall 111. In at least one embodiment, the second pivot 117 can be fixed to the arc-shaped rod body 1240 or protrude from the arc-shaped rod body 1240; a corresponding hole (no visibly) can be defined on the bottom wall 111; and the second pivot 117 can receive in the corresponding hole to rotatably couple the arc-shaped push rod 124 to the bottom wall 111.

As shown in FIG. 1, the latching portion 1242 can receive in the notch 1213. In detail, when the latching portion 1242 is received in the notch 1213, the tray 121 can be engaged with the housing 11, and when the latching portion 1242 is slipped out the notch 1213, the tray 121 can be disengaged from the housing 11.

In at least one embodiment, the tray 121 can include a hook (not shown), and the hook can engage with the latching portion 1242 to engage the tray 121 with the housing 11. In at least one embodiment, the tray 121 can be engaged with the housing 11 by other ways.

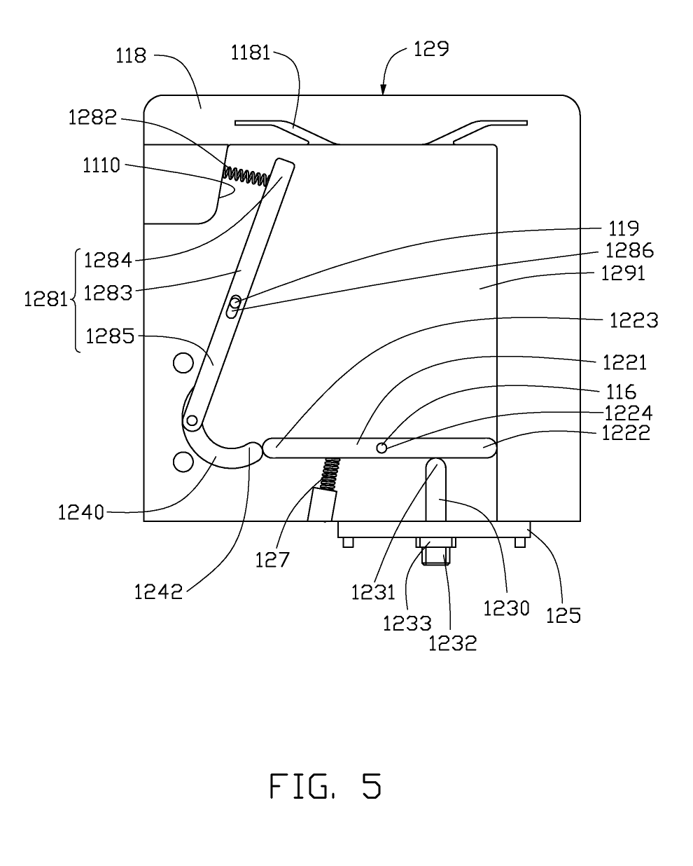

As shown in FIG. 5, the second push rod 123 can be driven to slide in the first slide groove 115 along a direction close to the first arm 1222. The first push rod 122 can be thus driven to rotate about an axis of first pivot 116 by the second push rod 123. What the result of rotation of the first push rod 122 can be that the first arm 1222 moves away from the peripheral sidewall 112, the second arm 1223 moves close to the peripheral sidewall 112, and the second arm 1223 further resists the latching portion 1242 and drives the arc-shaped push rod 124 to rotate about the axis of the second pivot 117 until the latching portion 1242 disengages from the notch 1213.

As shown in FIG. 2, the electronic card connector 12 can include an ejection member 126. The ejection member 126 can include a fixing end 1261 and an ejection end 1262. The fixing end 1261 can be attached to the bottom wall 111. The ejection end 1262 can resist one end of the tray 121 away from the peripheral sidewall 112. In this embodiment, the ejection end 1262 can be arc-shaped. The fixing end 1261 can be extended from two ends of the ejection end 1262. The fixing end 1261 and the ejection end 1262 can cooperatively form an arc-shaped elastic element. In at least one embodiment, the fixing end 1261 can be extended from only one end of the ejection end 1262. The fixing end 1261 and the ejection end 1262 can cooperatively form an S-shaped elastic element.

In this embodiment, the bottom wall 111 can further include a first limited wall 118 protruded therefrom. The ejection member 126 can be located between the first limited wall 118 and the tray 121, and the fixing end 1261 can be fixed to the first limited wall 118.

Furthermore, in this embodiment, the limited wall 118 can define a slot 1181. The slot 1181 can be used to fix the fixing end 1261. The ejection end 1262 can protrude from the slot 1181 and resist the one end of the tray 121 away from the peripheral sidewall 112. The ejection member 126 can be compressed when the tray 121 can be engaged with the housing 11.

The electronic card connector 12 can further include a first return member 127. The first return member 127 can be located between the second arm 1223 and the peripheral sidewall 112. In this embodiment, the first return member 127 can be a spring, one end of the first return member 127 can be fixed to the second arm 1223, and the other end of the first return member 127 can be attached to the bottom wall 111. In at least one embodiment, the one end or two ends of the first return member 127 cannot be fixed. The first return member 127 can be in a natural state when the tray 121 can be engaged with the housing 11 and in a compression state when the tray 121 can be ejected from the housing 11. The elastic restoring force of the return member 127 can drive the first push rod 122 to rotate about the axis of the first pivot 116, thus causing the first arm 1222 to move close to the peripheral sidewall 112 and the second arm 1222 to move away from the peripheral sidewall 112.

The electronic card connector 12 can further include a second return member 128. The second return member 128 can include a return rod 1281 and a return spring 1282. The return rod 1281 can include a return rod body 1283, a third end 1284 and a fourth end 1285. The third end 1284 and the fourth end 1285 can be located on two ends of the return rod body 1283. One end of the return spring 1282 can be attached to the bottom wall 111, and the other end of the return spring 1282 can be fixed to third end 1284 of the return rod 1281. The fourth end 1285 of the return rod 1281 can be rotatably coupled to the arc-shaped rod body 1240. In this embodiment, the bottom wall 111 can include a second limited wall 1110; the return spring 1282 can be located between the second limited wall 1110 and the third end 1284; and the return spring 1282 can be further fixed to the second limited wall 1110. The return rod body 1283 can define a guide groove 1286. The bottom wall 111 can further include a guide post 119. The guide post 119 can pass the guide groove 1286 to guide the movement of the return rod 1281.

In this embodiment, the electronic card connector 12 can further include a base 129. The base 129 can be fixed to bottom wall 111 and further face the opening 114. The first pivot 116, the second pivot 117, the first limited wall 118, the guide post 119 and the second limited wall 1110 can be both located on the base 129. The first limited wall 118 can be substantially perpendicular to the second limited wall 119, and the first limited wall 118 can face the opening 114. The one end of the first return member 127 can be fixed to the base 129. The first limited wall 118, the second limited wall 1110 and the peripheral sidewall 112 can cooperatively form a second receiving space 1291. The second receiving space 1291 can be used for accommodating the tray 121.

Referring to FIGS. 1, 4 and 5, when in assembly, the base 129 can be attached to the bottom wall 111; the ejection member 126 can be partially accommodated in the slot 1181; the first push rod 122 can be rotatably attached to the base 129 via the first pivot 116; the arc-shaped push rod 122 can be rotatably attached to the base 129 via the second pivot 117; the return spring 1282 can be connected between the second limited wall 1110 and the third end 1284 of the return rod 1281; the fourth end 1285 of the return rod 1281 can be rotatably coupled to arc-shaped push rod 124; the first end 1231 of the second push rod 123 can be pushed to pass through the second slide groove 1251 of the resist member 125 and then resist the first rod body 1221, the second end 1232 of the second push rod 123 can be pushed to pass through the first slide groove 115 to protrude from housing 11; the resist member 125 can be resisted the protrusion 1233 and fixed on the interior of the peripheral sidewall 112; the tray 121 can be pushed to pass through the opening 114 and receive in the first receiving space 113; the latching portion 1242 of the arc-shaped push rod 124 can be pushed to receive in the notch 1213 to engage the tray 121 with the housing 11. At this moment, the electronic card connector 12 can be in a locked state, the second end 1232 of the second push rod 123 can be located in one side of the slide groove 115 away from the first arm 1222, the ejection member 126 can be in a compression state, the first return member 127 and the second return member 128 can be both in a national state.

If a user wants to take out the electronic card 13 from the defined space 1212 or put a new electronic card in the defined space 1212, an external force can be applied on the second end 1232 of the second push rod 123 to cause the second push rod 123 to slide in the first slide groove 115, the first push rod 122 can be thus pushed to rotate about an axis of the first pivot 116, thereby causing the first arm 1222 to move away from the peripheral sidewall 112, and the second arm 1222 to move close to the peripheral sidewall 112, and causing the second arm 1222 to resist the latching portion 1242 and drive the arc-shaped push rod 124 to rotate about the axis of the second pivot 117 until the latching portion 1242 disengages from the notch 1213, the first return member 127 can be in a compression state, and the second return member 128 can be in a stretching state, the tray 121 can be disengaged with the housing 11. The elastic restoring force of the ejection member 126 can drive the tray 121 to slide out from the opening 114. The electronic card 13 can be taken out from the defined space 1212 or the new electronic card can be put in the defined space 1212. The electronic car connector 12 can be in an unlocked state.

The elastic restoring force of the first return member 127 can drive the first push rod 122 to rotate in an opposite direction, the second arm 1223 can thus move away from the peripheral sidewall 112, the first arm 1222 can thus move close to the peripheral sidewall 112 until the first return member 127 can be in a natural state. The elastic restoring force of the return spring 128 can pull the return rod 1281 to rotate so as to push the arc-shaped push rod 124 to move close to the tray 121 until the latching portion 1242 of the arc-shaped push rod 124 can be received in the notch 1213 of the tray 121.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a housing comprising a bottom wall and a peripheral sidewall, the bottom wall and the peripheral sidewall cooperatively defining a receiving space, the peripheral sidewall defining an opening and a first slide groove, and
an electronic card connector comprising:
a tray defining a defined space for accommodating an electronic card, the tray passing through the opening to receive in the receiving space;
a first push rod rotatably attached to the bottom wall and comprising a first arm and a second arm;
a second push rod comprising a first end and a second end, the first end resisting the first push rod, the second end passing through the first slide groove and protruding from the housing; and
an arc-shaped push rod comprising a fixing portion rotatably attached to the bottom wall and a latching portion, the latching portion engaging the tray with the housing,
wherein the second push rod is driven to slide in the first slide groove to rotatably push the first push rod, the first arm is configured to move away from the peripheral sidewall, and thereby cause the second arm to move close to the peripheral sidewall and resist the latching portion, and cause the second arm to drive the arc-shaped push rod to rotate so as to disengage the latching portion with the tray.

2. The electronic device of claim 1, wherein the defined space is defined on the tray, the tray further defines a notch facing the bottom wall, when the latching portion receives in the notch, the tray is engaged with the housing, and when the latching portion slips out the notch, the tray is disengaged with the housing.

3. The electronic device of claim 1, wherein the bottom wall comprises a first pivot, the first push rod further comprises a first rod body located between the first arm and the second arm, the first rod body defines a first through hole, and the first pivot passes the first through hole to rotatably attach the first push rod to the bottom wall.

4. The electronic device of claim 1, wherein the second push rod further comprises a second rod body located between the first end and the second end, the second rod body comprises a protrusion, a height of the second end is less than a height of the first slide groove, a sum of a height of the second rod body and a height of the protrusion is greater than the height of the first slide groove, the protrusion resists the peripheral sidewall; the electronic card connector further comprises a resist member, the resist member resists the protrusion and is fixed to the peripheral sidewall, and the second push rod slides in the first slide groove.

5. The electronic device of claim 1, wherein the bottom wall comprises a second pivot, the fixing portion of the arc-shaped push rod defines a second through hole, the second pivot passes through the second through hole to rotatably attach the arc-shaped push rod to the bottom wall.

6. The electronic device of claim 1, wherein the electronic card connector further comprises an ejection member, the ejection member comprises a fixing end and an ejection end, the fixing end is fixed to the bottom wall, the ejection end resists the tray, when the tray is engaged with the housing, the ejection member is compressed, and when the tray is disengaged with the housing, an elastic restoring force of the ejection member pushed the tray to slip out the opening.

7. The electronic device of claim 6, wherein the bottom wall comprises a first limited wall, the ejection member is located between the first limited wall and the tray, and the fixing end is fixed to the first limited wall.

8. The electronic device of claim 1, wherein the electronic card connector further comprises a first return member, the first return member is located between the second arm and the peripheral sidewall, the first return member is in a natural state when the tray is engaged with the housing or in a compression state when the tray is ejected from the housing, and an elastic restoring force of the return member drives the first push rod to rotate to cause the first arm to move close to the peripheral sidewall and the second arm to move away from the peripheral sidewall.

9. The electronic device of claim 1, wherein the electronic card connector further comprises a second return member; the second return member comprises a return rod and a return spring, the return rod comprises a third end, a fourth end and a return rod body located between the third end and the fourth end, one end of the return spring is attached to the bottom wall, and the other end of the return spring is fixed to third end of the return rod, the fourth end of the return rod is rotatably coupled to the arc-shaped rod body.

10. The electronic device of claim 9, wherein the bottom wall comprises a second limited wall, the return spring is located between the second limited wall and the third end, the one end of the return spring is fixed to the second limited wall.

11. The electronic device of claim 9, wherein the return rod body defines a guide groove, the bottom wall comprises a guide post, the guide post passes through the guide groove to guide movement of the return rod.

12. An electronic card connector, applied on an electronic device, the electronic device comprising a housing, the housing comprising a bottom wall and a peripheral sidewall, the bottom wall and the peripheral sidewall cooperatively defining a receiving space, the peripheral sidewall defining an opening and a first slide groove, the electronic card connector comprising:
a tray defining a defined space for accommodating an electronic card, the tray passing through the opening to receive in the receiving space;
a first push rod rotatably attached to the bottom wall and comprising a first arm and a second arm;
a second push rod comprising a first end and a second end, the first end resisting the first push rod, the second end passing through the first slide groove and protruding from the housing; and
an arc-shaped push rod comprising a fixing portion rotatably attached to the bottom wall and a latching portion, the latching portion engaging the tray with the housing;
wherein the second push rod is driven to slide in the first slide groove to rotatably push the first push rod, the first arm is configured to move away from the peripheral sidewall, and thereby cause the second arm to move close to the peripheral sidewall and resist the latching portion, and cause the second arm to drive the arc-shaped push rod to rotate so as to disengage the latching portion with the tray.

13. The electronic card connector of claim 12, wherein the defined space is defined on the tray, the tray further defines a notch facing the bottom wall, when the latching portion receives in the notch, the tray is engaged with the housing, and when the latching portion slips out the notch, the tray is disengaged with the housing.

14. The electronic card connector of claim 12, wherein the second push rod further comprises a rod body located between the first end and the second end, the rod body comprises a protrusion, a height of the second end is less than a height of the first slide groove, a sum of a height of the rod body and a height of the protrusion is greater than the height of the first slide groove, the protrusion resists the peripheral sidewall; the electronic card connector further comprises a resist member, the resist member resists the protrusion and is fixed to the peripheral sidewall, the second push rod slides in the first slide groove.

15. The electronic card connector of claim 12, wherein the electronic card connector further comprises an ejection member, the ejection member comprises a fixing end and an ejection end, the fixing end is fixed to the bottom wall, the ejection end resists an end of the tray away from the peripheral sidewall, when the tray is engaged with the housing, the ejection member is compressed, and when the tray is disengaged with the housing, an elastic restoring force of the ejection member pushed the tray to slip out the opening.

16. The electronic card connector of claim 15, wherein the bottom wall comprises a first limited wall, the ejection member is located between the first limited wall and the tray, and the fixing end is fixed to the first limited wall.

17. The electronic card connector of claim 12, wherein the electronic card connector further comprises a first return member, the first return member is located between the second arm and the peripheral sidewall, the first return member is in a natural state when the tray is engaged with the housing or in a compression state when the tray is ejected from the housing, and an elastic restoring force of the return member drives the first push rod to rotate to cause the first arm to move close to the peripheral sidewall and the second arm to move away from the peripheral sidewall.

18. The electronic card connector of claim 12, wherein the electronic card connector further comprises a second return member; the second return member comprises a return rod and a return spring, the return rod comprises a third end, a fourth end and a return rod body located between the first end and the second end, one end of the return spring is attached to the bottom wall, and the other end of the return spring is fixed to third end, and the fourth end is rotatably coupled to the arc-shaped rod body.

19. The electronic card connector of claim 18, wherein the bottom wall comprises a second limited wall, the return spring is located between the second limited wall and the third end, the one end of the return spring is fixed to the second limited wall.

20. The electronic card connector of claim 18, wherein the return rod body defines a guide groove, the bottom wall comprises a guide post, and the guide post passes through the guide groove to guide movement of the return rod.
